(19) United States
(12) Patent Application Publication
(10) Pub. No.: US 2006/0130690 A1
(43) Pub. Date: Jun. 22, 2006

(54) Printing member having a transferred image and a method for fabricating it

(76) Inventor: Avigdor Bieber, Ra'anana (IL)

Correspondence Address: PEARL COHEN ZEDEK, LLP, 1500 BROADWAY 12TH FLOOR, NEW YORK, NY, 10036, US

(21) Appl. No.: 10/560,746

(22) PCT Filed: Jun. 16, 2004
(86) PCT No.: PCT/IL04/00519

§ 371 Date: Dec. 15, 2005

Related U.S. Application Data
(60) Provisional application No. 60/479,157, filed on Jun. 18, 2003.

(51) Int. Cl. B41N 3/00

(52) U.S. Cl. 101/467

(57) ABSTRACT

A lithographic printing member (300) comprices a solid substrate (230) over the substrate, wherein the tip layer comprises a first area (320b) having an affinity for ink and a second area (320a) having an affinity for an ink repelling fluid. The two types of surface areas are fabricated by dipping imaging carry material (320b) into a fluid mixture of the top layer during fabricating of the top layer. The method of fabricating the printing member (300) may comprise providing a substrate (230), providing an imaged transfer film (110), coating the substrate or the image transfer film with a liquid formulation; laminating the image transfer film (110) with the substrate (2330) over the liquid formulation while dipping the image carry material (320b) into the liquid formulation, curing the liquid formulation into a solid layer (220), and releasing the image transfer film (110) and revealing the two types of surface areas (320a, 320b).

### BACKGROUND

1. Field of Invention

The invention relates to the field of printing apparatus and methods, and more particularly to manufacturing of lithographic printing-member that is used in offset printing systems.

2. Description of Background Art

In offset lithography printing, an image is presented on a lithographic printing member such as a printing plate or a printing cylinder having a pattern of ink-accepting (oleophilic, hydrophobic) and ink-repellent (oleophobic, or hydrophilic) surface areas. There are two offset printing methods, a wet method and a dry method. The wet method, which is the traditional method, uses a fluid that is dampened (or “fountain”) to the printing member prior to the ink. The fluid, such as but not limited to water, covers the ink-repellent surface areas and repels the ink that is applied later to the printing plate, but does not affect the oleophilic character of the image areas. Therefore, traditionally, the non-image areas are called hydrophilic areas while the ink-accepting areas are called hydrophobic area.

Offset printing systems use a lithographic printing member having at least two layers. The two layers have different affinity for printing ink. One layer is made of oleophobic material that rejects ink, such as but not limited to silicone rubber. While the other layer is made of oleophilic material such as polyester. Therefore, in dry printing systems the plate is simply inked and the ink is carried by the oleophilic areas that were exposed imagewise.

It should be noted that the terms “printing member”, “printing plate”, “lithographic printing member” and “plate” are used interchangeably herein. It also should be noted that the terms “ink-accepting”, “oleophilic” and “hydrophobic” are used interchangeably herein and it should be noted that the terms “ink-repellent”, “oleophobic” and “hydrophilic” are used interchangeably herein.

In both methods the image is patterned over the plate creating ink-accepting (oleophilic) and ink-rejecting (oleophobic) surface areas. Ink that is applied to lithographic printing member is carried by the oleophilic areas and is transferred to a recording medium in the imagewise pattern. Typically, the printing member first makes contact with an intermediate surface called a blanket cylinder, which, in turn, applies the image ink to the paper or other recording medium.

There are several ways to expose the image over a printing member. Some of those methods involves direct computer to plate (CTP) equipment. CTP equipment exposes the image over a printing plate by using IR laser, for example, which is controlled by a computer. Common printing members that are exposed directly from computer may have two or three layers. In case of a printing plate with three layers, the top layer may be an ink-rejecting layer, such as silicone rubber. The second layer, beneath the top layer, may be a laser absorbing layer or a laser ablation layer. The third layer, beneath the second layer, may be but not limited to, a polyester layer. The polyester layer is the ink-receptive layer. In printing plates with two layers the top layer, which is an ink-rejecting layer, may comprise also laser-absorbing particles, IR absorbers.

Common imaging method of a printing member exposes the printing member imagewise by a computer control laser radiation, usually using Infra Red (IR) radiation or near IR. The imagewise IR radiation elevates the temperature of the IR absorber and deanchoring the top layer, the oleophobic layer. Relative high-energy laser radiation is required for exposing common printing members in order to deanchor the top layer. Therefore common computer to plate equipments (CTP) are expensive and require long exposure time.

Other types of printing plates, AGFA Lithostar plate for example, may have a top layer that is not ablated under laser radiation. However, those plates may need post process treatment such as developing stage. AGFA Lithostar is AGFA's trademark.

Additional type of plates is plate that is printed directly over a polyester based film, such as XANTE's plate. However, this type of plates is limited to wet printing. Furthermore, This type of plate may not be used in printing machines that require aluminum plates.

Some common method may require additional post treatment such as removing debris, which is due to the deanchoring process, for exposing the ink-accepting layer according to the image. The post cleaning treatment may scratch the surface of the printing member. The scratches may cause visible defects in the printed image. In addition, common post treatment involves cleaning and washing with chemicals. Usually such a post treatment is not environmental friendly.

General printing members may use a thin metal layer as a second layer. The metal layer may be used as an imaging layer for absorbing the radiation and ablating the top layer. Those additional layers complicate the manufacturing of the printing member as well as increasing their cost. Furthermore the fabrication equipment of current printing plates is expensive, complicated, and requires a large facility.

Another prior art method for exposing an image over a printing plate by a computer is a thermal transfer method. Those methods are using a donor blank and an acceptor substrate. The donor blank may have a transparent film that is covered by transfer material. The transfer material and the acceptor substrate have different affinity to ink and/or to ink repellent fluid. Before exposing the image by a CTP, the transfer layer of the donor blank is held in intimate contact with the acceptor substrate. Then the two films are imagewise exposed by a laser radiation. The imagewise irradiating causes imagewise displacement of the transfer material from the transparent film of the donor blank onto the acceptor substrate. Removing the donor film from the acceptor substrate reveals the ready printing member. Using these methods requires less laser energy than the previous method.

Common method for preparing ready to print plates delivers printing member surface that is not flat. Common surface may have two levels. The base line, which may be the oleophilic area, and the oleophllic area that may be above it. The two levels surface is wearing during the printing and may limit the number of copies that can be printed by a printing plate.

Furthermore, there is a plurality of printed-paper size standards, such as ‘A’ type, ‘B’ type. Each type is divided into a plurality of sizes such as A4; A3; A2; A1; B4; B3 etc. . . . Moreover, common suppliers of printing plates may have a plurality of printing members that fit the same paper size, such as A1, but differ from each other in small variations in their physical dimensions. The reason for those variations is optimizing the size of the plate for the current printing job, the current page size and the current printing machine. Common printing plate producer may have more than 40 different part numbers of printing plats that may fit A2 paper size, for example.

Thus, it is evident that current technologies of fabricating printing members create significant difficulties in handling and utilizing current printing plates. Therefore, there is a need in the art for new printing members. The new printing members may be fabricated by using simple methods and equipments. Equipment that may be installed in a printing house and may create printing plates on demand, upon needed.

Furthermore, there is a need for new method for applying the image over the printing member that reduces the cost of the CTP equipment as well as increasing the speed. Such a CTP may be installed in common printer shop, or in office environmental.

In addition, there is a need for printing plates that will be processed in more environmental friendly methods. Such methods that do not need post processing, cleaning and removing residual materials and or debris. There is still an additional need that those printing members will have sufficient flat surface that may survive long runs.

### SUMMARY OF THE INVENTION

The present invention solves the above-described needs by providing less expensive lithographic printing member and method for fabricating and imaging them. The lithographic printing member that is built according to the present invention may be r made on demand by a printing house using affordable equipment. In addition, Transferring the image by the computer to the printing member may be done by simple imaging equipment such as but not limited to common laser printer or common inkjet printer. Furthermore the ready to print plate may have sufficient flat surface. An advantage that increases the number of copies that can be printed. The on demand feature enables delivering an imaged single plate upon needed at the appropriate size, thickness and formulation that meet printing needs. Those features may be changed from one plate to the other by computer commands.

In general, common offset printing plates having at least two layers, one above the other, which are in contact with the ink and/or the ink-repellent fluid (incase of wet printing). Wherein the two layers differ from each other by their affinity to the ink and/or to the ink-repellent fluid. The first layer and the second layer have different affinity to ink and/or to ink-repellent fluid. The present invention may have a single layer that is in contact with the ink and/or the ink-repellent fluid. The layer has two different types of surface areas, a first type and a second type. The location of the two different types of surface areas in the top layer of the printing member is imagewise and reflects the printed image. The first type of surface area and the second type of surface area have different affinity to ink and/or to ink-repellent fluid. Creating the two types of areas, according to the image, is done during curing the top layer of the printing member.

According to the present invention, preparing a printing member is done in two stages. During the first stage, the imaging stage, the required image is printed by a computer over an Image Transfer Film (ITF). The present invention is using Imaging Carry Material (ICM) that is printed imagewise over the ITF. The ICM may be printed over the ITF by using Computer Transfer to Plate Printer (CTtP). The CTtP printer may be common computer printer, using common technology, such as: Electro Photographic (electrostatic printers), Inkjet, Ionographia, Wax Thermal Transfer etc. An exemplary CTtP printer may be common; laser printer, such as but not limited to Black/white OKIPAGE laser printer. An exemplary ICM may be OKIDATA toner. The image may be printed over an Image Transfer Film (ITF). The ITF may be a clear smooth film that may be transparent to Ultra-Violet (UV) light. The ITF may have low surface energy. An exemplary ITF may be made of materials such as but not limited to polyethylene, polypropylene, polytetrafluoroethylene, silicone-coated polyester. An exemplary ITF may be Silicone coated PET release film LE951E of DuPont. The image may be printed over the silicone-coated side of this film. The ITF may be laminated over a transparent substrate. The transparent substrate may be used for improving the mechanical properties of the ITF. However, the present invention is not limited to this example. Other embodiments may use other type of laser printer, other toners having the appropriate properties that are disclosed below and other types of ITFs. It should be noted that the terms “toner” and “Imaging Carry Material (ICM)” might be used interchangeably herein.

During the second stage the printing member is fabricated. The printing member may be fabricated by coating a substrate by a fluid mixture of a formulation of a layer. The substrate does not interact with the printing inks; it just delivers the required mechanical properties of the printing member. Therefore the substrate may be made of any material that has good adhesion to the mixture of the layer as well as the mechanicals properties that are needed by printing machine. Common thickness of the substrate may be in the range of 0.003 to 0.02 inch (about 0.08 mm to 0.5 mm). A wide variety of materials may be used for fabricating the substrate such as but not limited to plastic, polymers, paper, metal, etc. In particular the substrate may be made of polyvinylchlorides (PVC), polyesters, polycarbonates, aluminum, etc.

The fluid mixture of the formulation of the layer may be made of oleophobic material such as but not limited to silicone epoxy or silicone acrylate polymer. The silicone epoxy or silicone acrylate polymer may be coated over the substrate by using methods that are called, in this discloser, coating by wet lamination process and coating by ironing lamination. According to those methods, the formulation of the layer, which is a fluid, is applied or poured over the substrate instead of glue that is used in common lamination processes. Then, the ITF with the printed image is laminated above the fluid while the image facing the mixture, forcing the material of the printed ICM into the oleophobic mixture. During this stage the ITF is used as a form film that forms the surface of the coated layer.

In some embodiments of the present invention that use wet lamination process the formulation may be applied by methods such as but not limited silkscreen, a wire-wound rod, offset coating, gravure etc. Then the ITF may be laminated over the coating.

In alternate embodiments the fluid formulation may be applied or poured over the imaged ITF and the substrate is laminated over the coated imaged ITF. More information on coating by wet; lamination process and coating by ironing lamination process can be found in the; international publication number WO04/014651 of international application number PCT-IL03/00652 the content of which is incorporated herein by reference.

The sandwich comprising of the substrate, the fluid mixture and the imaged ITF are irradiated by TV radiation. The UV radiation cures the fluid mixture into a solid layer holding/anchoring the printed ICM into the layer. After the curing stage the ITF may be released or may be kept as a protection film to protect mechanically the ready to print plat. Before installing the printing plat over a press machine the ITF is released. While releasing the ITF, the ICM, which are dipped in the layer, are separated from the ITF and remain in the solid layer. The domains of the ICM in the solid layer forms two type of surface areas: oleophobic area, which is the clear surface of the mixture, and oleophilic area, which is the area that is covered by the ICM according to the image.

The present invention is not limited to UV curing. Other exemplary methods may use other curing methods such as but not limited to: thermal curing, catalytic curing, etc. The formulation of those embodiments may comprise instead or additionally to epoxy or acrylate groups, silicone component that may include other functional groups such as but not limited to vinyl, silane etc, that may provide crosslinking via addition cure, condensation cure, etc.

Other methods may use hot lamination process for dipping the ICM into the layer. In those methods, the layer of the plate may be made of thermoplastic material that covers the substrate of the plate. The thermoplastic material provides a solid coated layer. Then the imaged ITF and the plate undergo a hot lamination process. During the hot lamination the solid coated layer partially melt allowing the dipping of the ICM into the partially melt layer. At the end of the hot lamination process the partially melt layer is hardened back into a solid layer under environmental cooling.

An exemplary embodiment of the present invention may use sheet wet lamination apparatus for laminating sheet of imaged ITF over a printing plate. Other embodiments of the present invention may use an apparatus that prints over a continuous film of ITF using, for example, electro photographic technique. Then the printed film is laminated over the mixture of the layer of the printing plate before curing.

Thus, the present invention advantageously offers less expensive lithographic printing plate. The present invention teaches efficient and less expansive methods for exposing an image from a computer to the plate. Moreover, the present invention teaches a low cost method for delivering printing plates on demand. The offered printing plate may have sufficient flat surface and longer runs. Furthermore, fabricating an imaged ready to print plate, by an exemplary embodiment of the present invention, may be faster than imaging common plate and performing the post imaging process in order to make a common plate ready to print.

Other objects, features, and advantages of the present invention will become apparent upon reading the following detailed description of the embodiments with the accompanying drawings and appended claims.

### BRIEF DESCRIPTION OF THE DRAWINGS

FIG. 1a is a schematic top view of an imaged portion of an Image Transfer Film (ITF);

FIG. 1b is A-A′ schematic sectional view of the ITF of FIG. 1a;

FIG. 1c is an enlarged schematic sectional view of the marked area ‘B’ in FIG. 1b;

FIG. 2a is a schematic top view of the imaged portion of the ITF of FIG. 1a laminated over an exemplary printing plate;

FIG. 2b is C-C′ sectional view of the sandwich of FIG. 2a;

FIG. 2c is an enlarged schematic sectional view of the marked area ‘E’ in FIG. 2b;

FIG. 3a is a schematic top view of the imaged portion of an exemplary ready to print printing plate after releasing the ITF;

FIG. 3b is D-D′ sectional schematic view of the exemplary printing plate of FIG. 3a;

FIG. 3c is an enlarged schematic sectional view of the marked area ‘F’ in FIG. 3b;

FIG. 4a illustrates an exemplary apparatus that may be used for fabricating a printing member according to the present invention without imaging system;

FIG. 4b illustrates another exemplary apparatus that may be used for fabricating a printing member according to the present invention without imaging system;

FIG. 4c illustrates another exemplary apparatus that may be used for fabricating a printing member according to the present invention without imaging system;

FIG. 5a illustrates an exemplary stand-alone apparatus that may be used for fabricating a printing member according to the present invention with imaging system;

FIG. 5b illustrates another exemplary stand-alone apparatus that may be used for fabricating a printing member according to the present invention with imaging system.

### DETAILED DESCRIPTION OF THE INVENTION

Turning now to the figures in which like numerals represent like elements throughout the several views, exemplary embodiments of the present invention are described. For convenience, only some elements of the same group may be labeled with numerals. The purpose of the drawings is to describe exemplary embodiments and not for production. Therefore dimensions of components and features shown in the figures are chosen for convenience and clarity of presentation and are not necessarily shown to scale.

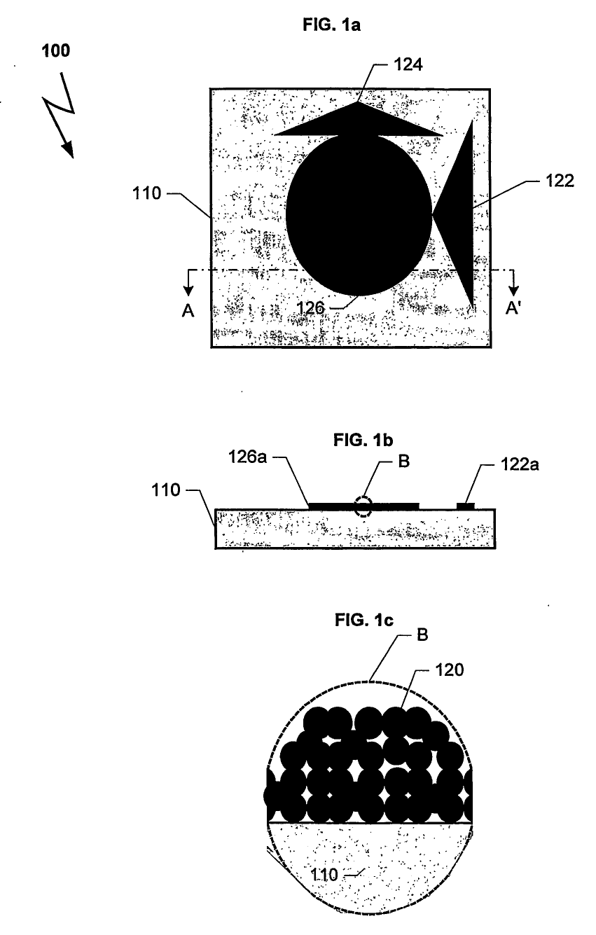

FIG. 1a is a schematic top view of an imaged portion of an exemplary Image Transfer Film (ITF) 110. ITF 110 is used as a transfer media on which the image 122, 124, 126 is printed by a computerized printer. Later, ITF is laminated over a printing plate, transferring the printed image into the printing plate.

An exemplary ITF may be a clear smooth film that is transparent to Ultra-Violet (UV) light. The ITF may have low surface energy and having release property in respect to the cured layer of the printing plate. An exemplary ITF may be made of materials such as but not limited to polyethylene, polypropylene, polytetrafluoroethylene, silicone-coated polyester. An exemplary ITF may be, but not limited to, Bioriented polypropylene TERFILMEC of Tervakoski Dielectrics Ltd or Rayoart CG90 of UCB Films, Silicone coated PET release film LE951E of DuPont, Silicone coated PET release film Hostaphan 2SLK of Mitsubishi Polyester Film, LLC, etc.

The rear side (the un printed side) of the ITF may be laminated over a transparent substrate (not shown in the drawings). The transparent substrate may be used for improving the mechanical properties of ITF 110 but it does not involved in the process of preparing a ready to print printing member.

The transparent feature is required in case of using UV curing to cure the formulation of the printing plate. However, in other exemplary embodiments, in which the curing method is not UV curing, or the lamination method is not wet lamination, the ITF may be opaque.

Other exemplary embodiments may use a release paper instead of a transparent film as the ITF. An exemplary released paper may be a sheet or web paper coated with silicon, such as but not limited to a paper that is used for carrying stickers. In those cases the substrate that may be used is transparent to UV and the UV radiation is done through the substrate. In alternate embodiment, in which the substrate is transparent, the UV curing may be done via the substrate and the ITF may be opaque. In other embodiment, in which the substrate and the ITF are transparent, the UV curing may be done from both sides, simultaneously, via the substrate and the ITF. During the imaging stage the ITF is printed by a Computer Transfer to Plate (CTtP) Printer. The CTtP printer may be common computer printer, using common technology, such as: Electro Photographic (electrostatic printers), Inkjet, Ionographia, Wax Thermal Transfer etc. An exemplary CTTP printer may be, but not limited to, Black/white OKIPAGE laser printer.

The exemplary printed image in FIG. 1a includes a circle 126 with two triangles, one 122 on the right side of circle 126 (from the reader's point of view) and the other 124 on the top of the circle 126. In case of using Silicone coated PET release film LE95 IE of DuPont as the film of ITF 110, the image is printed over the silicone side of ITF 110. The exemplary Image Carry Material (ICM) that is used in this example is OKIDATA toner. The adhesion of the ICM to ITF 110 needs to be in a level that delivers a stable image as well as enabling the ICM to be transferred from the ITF to the printing plate during the next stage.

Other exemplary embodiments may use other type of ICM. The ICM properties depend on the type of the CTTP that is used, the ITF and the required ink affinity property. Following are few properties of exemplary ICM material: small size, in the range of 0.1 to 10 micron, smooth round particles that is readily flow, lower fusing temperature.

Other exemplary ICM may be solution or melt able resin, such as but not limited to acrylate, polyester vinyl resins etc. Other material may be UV curable acrylate compound that may be added to the formulation. Colored material, such as dye or pigment, may be added to the ICM. The purpose of the colored material is just to illustrate the printed image.

An exemplary formula for an ICM may be like:
Ebecryl 860 epoxy acrylate oligomer of UCB—26%
UCAR Vinyl VMCH of Union Carbide/Dow—9%
Printex U carbon black of Degussa—0.6%
Irgacure 819 photoinitiator of Ciba—0.4%
Methyl-ethyl ketone—64%

FIG. 1b is a sectional side view of ITF 110 illustrating the ICM areas, 126a & 122a, along the line A-A′ of the circle 126 and the triangle 122 respectively. FIG. 1C is enlarged area ‘B’ in FIG. 1b illustrating the fixed ICM 120 over ITF 110. Fixing may be done in the CTTP printer or outside of the printer. The fixing may be done by several methods, such as but not limited to fusing, curing, drying etc. It should be noted that the terms “fusing”, “curing” and “drying” are used interchangeably herein and the henceforth, the description of the present invention may use the term ‘fusing’ as a representative term for any of the above group.

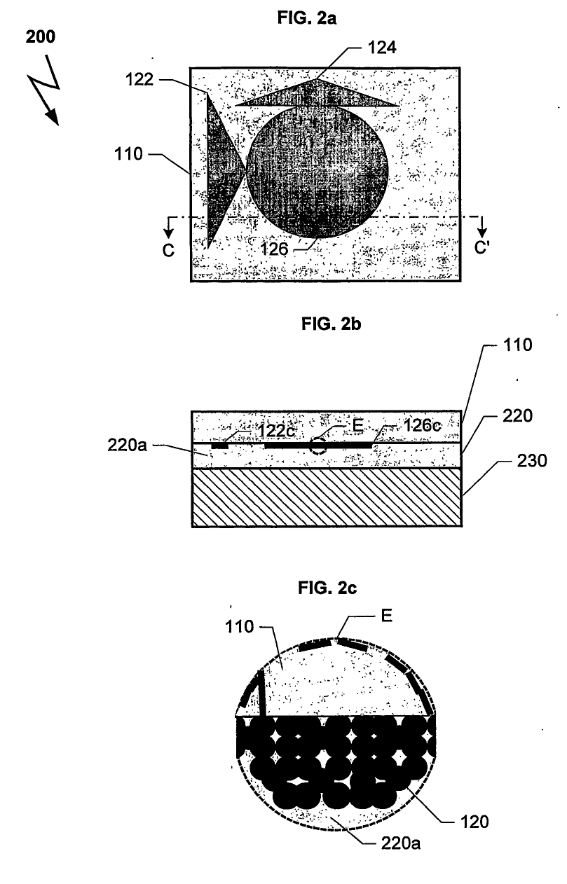

Referring now to FIG. 2a,b,c, FIG. 2a is a top view of the imaged portion of a printing plate sandwich 200. Printing plate sandwich 200 comprises upside-down imaged ITF 110 laminated over layer 220 (FIG. 2b) that is coated above substrate 230 (FIG. 2b). The printed side of ITF 110 is facing down toward layer 220. The ICM in the printed imaged as well as layer 220 of the printing plate may be seen through the transparent film of ITF 110. It can be observed that the printed image is the mirror image of the image in FIG. 1, the triangle 122 appears in the left side of circle 126.

FIG. 2b is a sectional side view of the exemplary printing plate sandwich 200 at the end of preparing the imaged plate. The figure illustrates the ICM areas, 126c & 122c, along the line C-C′ of the circle 126 and the triangle 122 respectively. The ICM areas, 126c & 122c, are dipped inside the mixture 220a of layer 220. The location of ICM 120 inside the mixture 220a is emphasized in FIG. 2c, which is enlarged view of the marked area ‘E’ in FIG. 2b. The fused ICM 120 is dipped inside mixture 220a forming a single layer 220.

The dipped ICM inside layer 220 forming a single layer with two different types of surface areas. The first type is the surface with the dipped ICM, which illustrated by areas 122, 124 & 126 (FIG. 2a). The second type is the clean surface area of layer 220. The first type of the surface area and the second type of the surface area have different affinity to ink and/or to ink-repellent fluid.

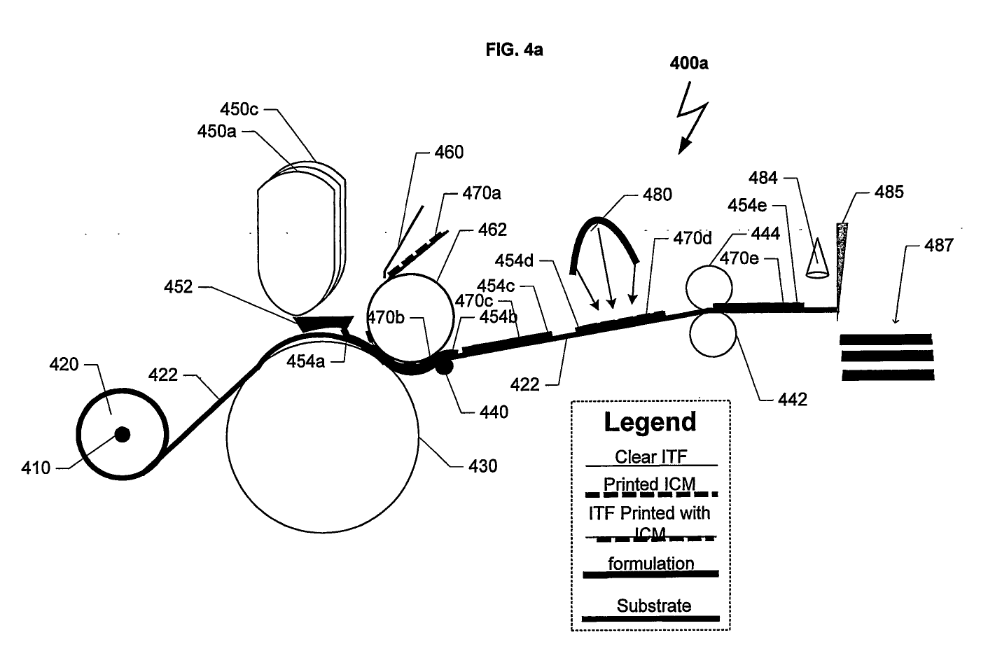

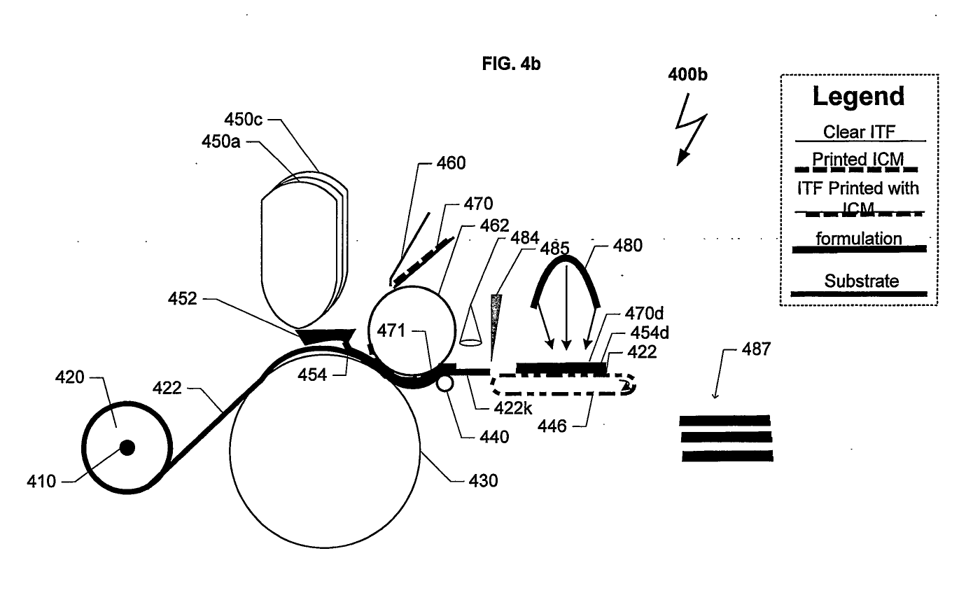

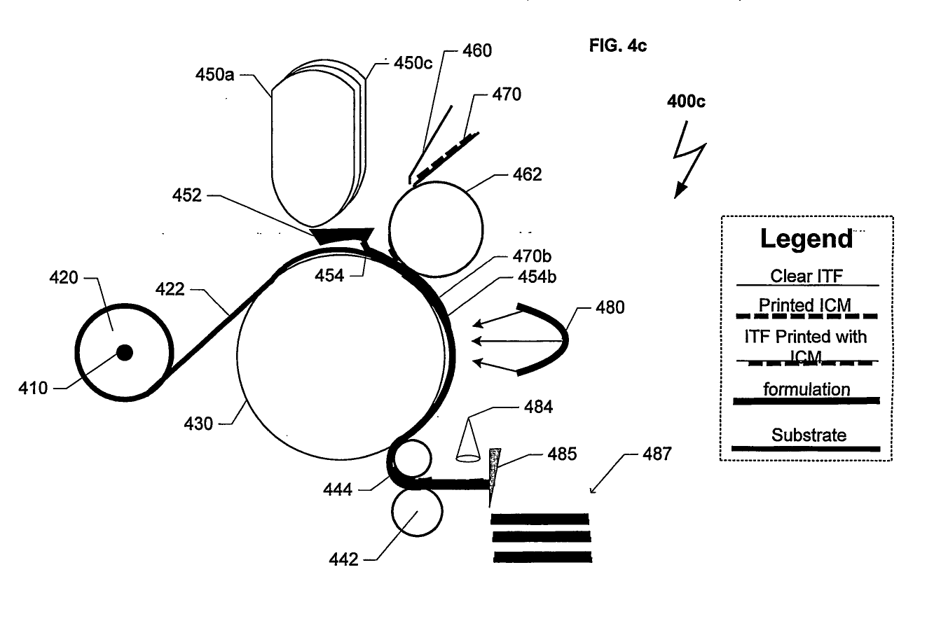

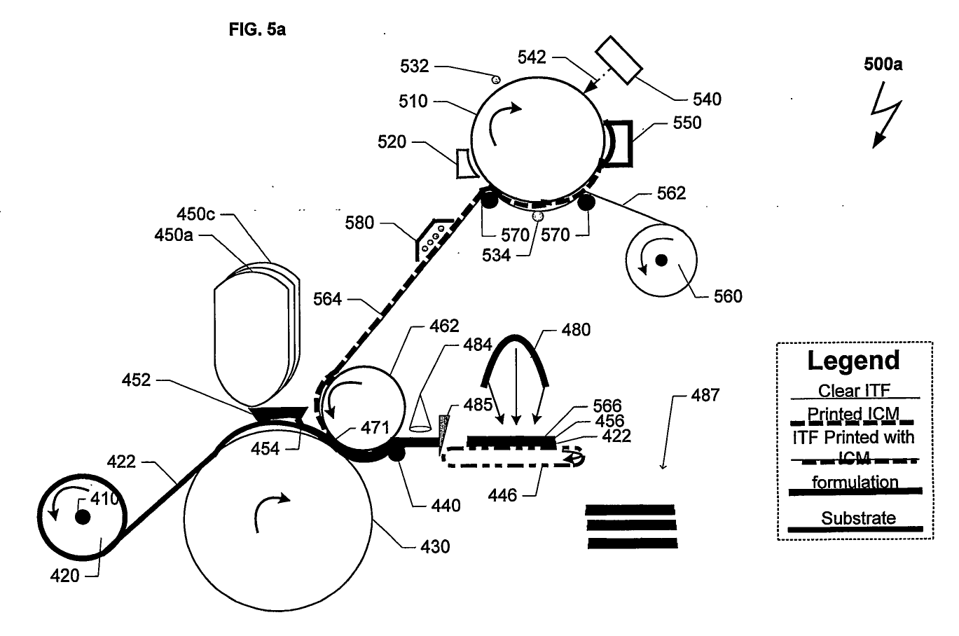

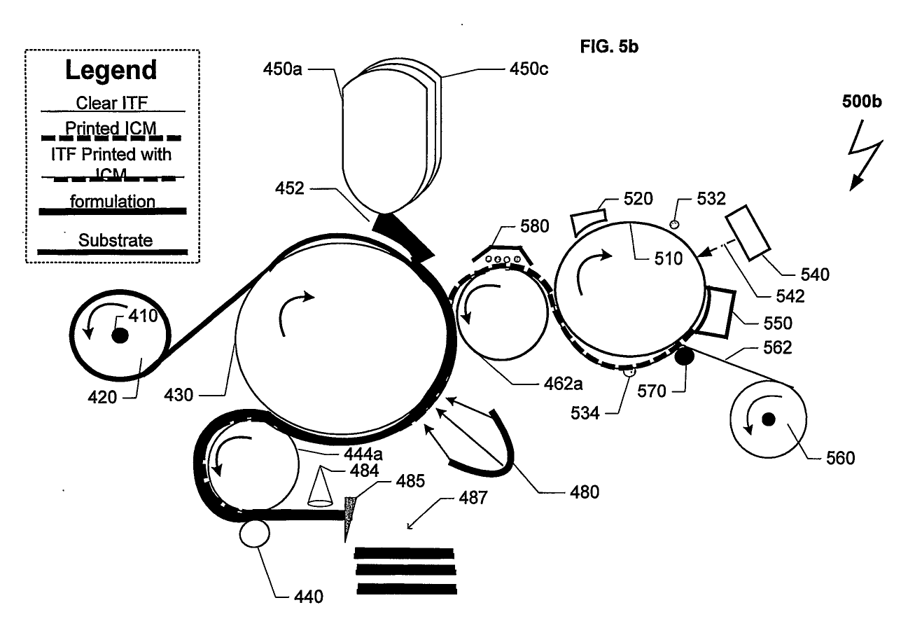

The mixture 220a may be coated over the substrate 230 by using methods that are referred, in this discloser, as coating by wet lamination process and coating by ironing lamination. Those methods are disclosed in details in conjunction with FIG. 4a-c and FIG. 5a-b. According to those methods, the mixture 220a, which is a fluid, is applied or poured over substrate 230 instead of glue that is used in common lamination processes. Then, the ITF 110 with the image is laminated above the fluid while the image facing the mixture 220a, forcing the ICM into the mixture 220a. During this stage the ITF 110 is used as a form film that forms the surface of the layer 220. Some physical properties of layer 220 may be influenced by the properties of film 110. Properties such as but not limited to face structure; thickness; surface tension; ink repellent/acceptance; scratches resistance; peel strength; etc.

The thickness of layer 220 may be in the range of 2 to 1000 microns. The thickness depends on the application. For offset printing the thickness may be in the range of few microns to tens microns, while for flexo or gravure the thickness may be in the range of few hundreds of microns.

Exemplary embodiment, which uses wet lamination, may use traditional coating methods for applying the fluid mixture 220a of the layer 220 over the substrate 230. Coating methods such as but not limited to silkscreen, a wire-wound rod, offset coating, gravure etc. After the coating the ITF 110 may be laminated over the coating.

The sandwich 200 comprising of the substrate 230, the fluid mixture 220a and the printed ITF 110 may be irradiated by UV radiation (not shown in FIG. 2a,b,c). The UV radiation cures the fluid mixture 220a into a solid layer 220 fixing the dipped printed ICM 120 into the layer.

During curing of the fluid mixture 220a good adhesion of ICM 120 to mixture 220a is generated, which considerable stronger than ICM adhesion to ITF 110. High anchorage between ICM 120 and layer 220 may be achieved due to the formulation of the mixture 220a, providing good adhesion to ICM 120. For example, mixture 220a may have some monomers like Genomer 1456 of Rahn and adhesion promoters like Sartomer 9051 of Cray Valley that provide good anchorage to OKIDATA toner.

Other exemplary embodiments may add components with acrylate functional groups to ICM 120. Those components may provide chemical binding of ICM 120 to the formulation 220a during UV irradiation.

After curing the ITF may be released or may be kept as a protection film to protect mechanically the ready to print plat. In cases that ITF film 110 is kept as protection film, the film may be released before installing the printing plat over a press machine. While releasing the ITF, the imaged ICM, which is dipped in layer 220, is separated from ITF 110 and remains in the solid layer 220 forming a single top layer with two types of surfaces.

Exemplary formulation for mixture 220a may comprise liquid polysiloxane substituted with functional groups such as but not limited to epoxy, acrylate, which may be cross linked by UV radiation. The formulation may comprise some additive, such as but not limited to adhesive promoters; modifiers that may improve the mechanical and surface properties of the oleophobic layer.

Following are few examples of formulations that may be used by the present invention for fabricating a printing plate that is used in dry printing process. For dry printing process the clean surface area of layer 220 is oleophobic while the surface with the dipped ICM is oleophilic.

### EXAMPLE 1

| | |
|---|---|
| Silcolease PC-970 silicone acrylate oligomer of Rhodia | 35%. |
| Genomer 1456 acrylate monomer of Rahn | 61%. |
| Sartomer 9051 adhesion promoter of Cray Valley, | 2%. |
| Darocure 1173 photoinitiator of Ciba Specialities | 1.4%. |
| Irgacure 819 photoinitiator of Ciba Specialities | 0.6%. |

### EXAMPLE 2

| | |
|---|---|
| UV9315 silicone epoxy oligomer of GE Silicone | 70%. |
| UV9440 silicone epoxy oligomer of GE Silicone | 17%. |
| Silquest 186A silane of OSi Specialties, | 9%. |
| 60% solution of Silcolease UV CATA 211 photocatalist | 4%. |
| of Rhodia in the mixture of methyl-ethyl ketone with | |
| isopropyl thioxantone | |

### EXAMPLE 3

| | |
|---|---|
| Silcolease PC-900 silicone acrylate oligomer of Rhodia | 73%. |
| Silcolease PC-970 silicone acrylate oligomer of Rhodia | 21%. |
| Sartomer 9051 adhesion promoter of Cray Valley, | 3%. |
| Darocure 1173 photoinitiator of Ciba Specialities | 3%. |

The present invention is not limited to UV curing. Other exemplary embodiments may use other curing methods such as but not limited to: thermal curing, catalytic curing, etc. The formulation of those embodiments may comprise instead or additionally to epoxy or acrylate groups, silicone component that may include other functional groups such as but not limited to vinyl, silane etc, that may provide crosslinking via addition cure, condensation cure, etc.

An exemplary formulation that may be used in wet printing process may have hydrophilic properties for accepting the fluid (such as water) that repels the printing ink, while the dipped ICM has hydrophobic characteristic. Exemplary formulation may comprise mixture of acrylates, which may be cured by UV radiation, having hydrophilic properties, acrylates of high polarity and additives such as surfactants, polyglycols and other.

The substrate 230 does not interact with the printing ink and/or the ink-repellent fluid; it delivers the required mechanical properties of the printing member. The substrate may be made of any material that has good adhesion to the mixture of the layer 220 as well as the mechanical properties that are needed by printing machine. Common thickness of substrate 230 may be in the range of 0.003 to 0.02 inch (about 0.08 mm to 0.5 mm). A wide variety of materials may be used for fabricating substrate 230, material such as but not limited to plastic, polymers, paper, metal, etc. In particular the substrate may be made of polyvinylchlorides (PVC) polyesters, polycarbonates, aluminum, etc.

Other exemplary embodiments may use a primer (not shown in the drawings) that is coated above substrate 230 before applying the fluid mixture 220a. The primer may be used to improve the adhesion of layer 220 to substrate 230.

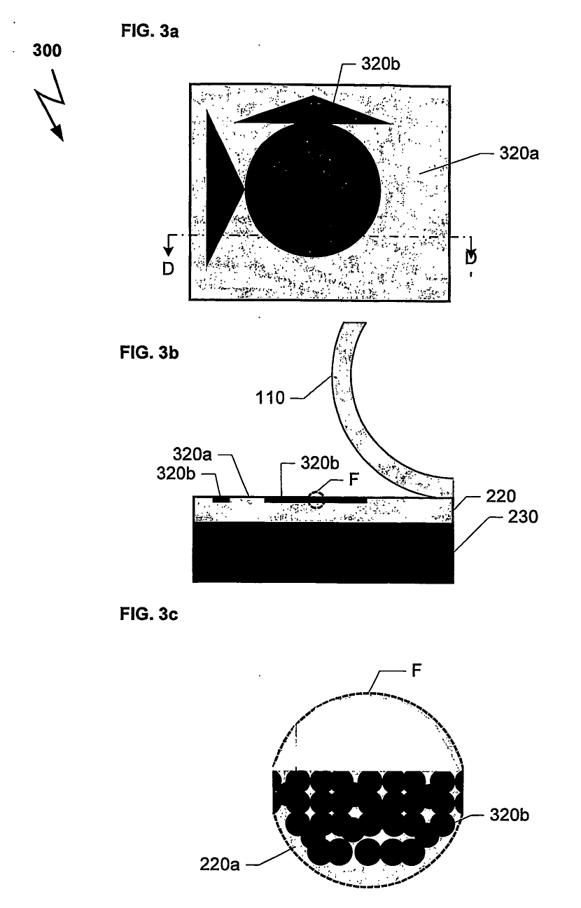

Referring now to FIG. 3a,b,c, FIG. 3a is a top view of a ready to print printing plate (RTPPP) 300 after releasing the ITF. RTPPP 300 may have two different types of surface areas, 320a (the doted color) and 320b (the solid black areas of the circle and the two triangles) that are in contact with the ink and/or the ink-repellent fluid. The location of the two different types of surface areas over the top layer 220 of the printing member 300 is the mirror image of the printed image. The first type of surface area and the second type of surface area have different affinity to ink and/or to ink-repellent fluid. Surface area 320a is the clean area of layer 220, which does not include any ICM. Usually surface area 320a has hydrophilic or oleophobic characteristic depending on the type of the printing process. A printing plate with hydrophilic characteristic is used in wet printing while a printing plate with oleophobic characteristic is used in dry printing. Surface 320b, which is formed by the dipped ICM according to the image, has oleophilic characteristic that caries the ink, according to the image, from an ink compartment to a paper via some intermediate surfaces. The direction of the image over RTPPP 300, a mirror or not, may be depended on the number of intermediate surfaces (blanket cylinder) that are used in the printing machine.

FIG. 3b is a sectional side view of the exemplary RTPPP 300 while releasing the ITF 110 before mounting the RTPPP 300 over a printing machine. The figure illustrates the side view of the two types of surface area along the cut line D-D′: the hydrophilic/oleophobic area 320a and the oleophilic area 320b. The oleophilic area 320b includes the ICM that is dipped and captured inside layer 220. Part of this area is emphasized in FIG. 3c, which is enlarged view of the marked area ‘F’ in FIG. 3b. The fixed ICM that is dipped and captured inside layer 220 generating the oleophilic characteristic of the surface of layer 220. The hydrophilic/oleophobic area 320a is the clean area without the ICM material.

The printing member of the present invention may be fabricated by several methods and different types of apparatus (Printing Plate Makers PPM). In general the PPM may be divided into three main groups. The first group includes PPM without imaging system. The second group includes stand alone PPM that has an imaging system. The third one may be composes from three separated units: imaging unit, lamination unit & curing unit (not shown in the drawings). The imaging system may be an engine of a computer printer. Exemplary imaging system may be an engine of a laser printer, an inkjet engine etc. Each of those groups may be divided into two-sub groups, sheet ITF handling mechanism or web ITF handling mechanism.

FIG. 4a illustrates an exemplary PPM 400a. PPM 400a is an exemplary PPM without imaging system and having a sheet ITF handling mechanism. Apparatus 400a may comprise a substrate handling mechanism for guiding/conducting the movement of substrate 422 at controlled speed and location. The substrate handling mechanism may comprise cylinder 410 that carries a roll 420 of substrate film 422; a set of cylinders that are represented by cylinders 430, 462 & 440, which press and guide the substrate in the appropriate path and a couple of drive rollers 442 & 444, that is actuated by a control motored (not shown) and pulls substrate 422 in the appropriate speed and location.

Apparatus 400a may have a formulation mixing mechanism that may include one or more than one cartridges 450a-c, an applicator 452 for mixing and spreading the formulation 454a over the substrate 422 and a controller (not shown) that controls the quantities of each component that composes the formulation. Three cartridges 450a-c are shown by way of example, any number of cartridges may be used by the present invention.

A lamination handling mechanism for guiding/conducting the movement of imaged ITF 470a-b sheets, at controlled speeds and location in refer to substrate 422. The lamination mechanism may include sheet feeder 460 that carries one or more than one imaged ITF 470a sheets. The printed image over ITF 470a is facing upwardly. At the appropriate time, sheet feeder 460 releases one imaged ITF 470a over a transfer mechanism 462 that carries the ITF toward substrate 422. The sheet transfers mechanism is represented by roller 462. Several methods may be used for holding the ITF over the transfer mechanism 462. An exemplary embodiment may use localized vacuum, other example may use controllable electrostatic forces to pull and hold the ITF over roller 462. Other embodiments may use other methods such as grippers, registration pins, clamping system, or any other method that are common in the printing art, including manual handling.

A UV curing mechanism 480 may be used for curing the formulation 454. At the end of apparatus 400a a cutting system 485 may be used for cutting the ready to print printing member into ready to print printing plates 487. The cutting may be done in both axis. In front of the cutting system 485 apparatus 400a may have an optical system 484 that search for marks on the printed ITF that indicate the cutting line. Optical system 484 may instruct the cutting system when to cut.

In other exemplary embodiments, the UV curing system 480 may be located below substrate 422. In those embodiments the substrate 422 is transparent to UV radiation. Other embodiments may have a UV curing system 480 in both sides of the substrate 422.

Other embodiments may use thermal curing instead of UV curing. In those embodiments element 480 may be an IR thermal energy source that may be located at one or both sides of substrate 422.

Roll 420 of substrate film 422 carries the substrate that is needed for fabricating printing member on demand. Substrate film 422 may be but not limited to plastic, polymers, paper, metal, etc. In particular the substrate may be made of polyvinylchlorides (PVC), polyesters, polycarbonates, aluminum. The substrate film 422 may be coated with a primer (not shown). Substrate film 422 may be transparent to UV or opaque. Several width of substrate film 422 may be used according to common printing formats. The width of substrate film 422 may fit many paper size standards such as but not limited to ‘A’ sizes and/or ‘B’ sizes such as A4; A3; A2; A1 and B4, B3 and B2 and small variations in their physical dimensions.

The formulation mixing mechanism may prepare, on demand, a mixture of the ingredients contained in the cartridges 450a to 450c. The controller (not shown) controls the cartridges to dispense the ingredients at a predefined component ratio to the mixing compartment 452 in which the homogenous mixture is prepared. The predefined ratio may be varied, according to the application, for optimizing the printing member to end user's ink; printing press and setup. Apparatus 400a may support a plurality of predefined ratios. Mixing compartment 452 may have a slot, or manifold, or a single aperture through which the formulation is poured.

Other embodiments may use a manual dispenser for applying the formulation in the junction of substrate 422 and ITF 470a.

The operation of apparatus 400a is done in stages. Each stage may match the timing of handling one ITF sheet. The operation is described using several stages. The stages are indexed by letters ‘a’ to ‘e’ along the process and in the drawing. At the appropriate time, the initial stage ‘a’ starts, the servomechanism (not shown) that controls the movement of substrate film 422 starts pulling the substrate along its path. Then the mixture 454a is poured at the appropriate time and at a predefined flow over film 422 close to the junction with the transfer mechanism 462. In parallel one of the imaged ITF 470a is loaded from the sheet feeder 460 and is carried by the transfer mechanism 462.

Following is stage ‘b’ the ironing lamination stage, in which the imaged ITF sheet 470b is applied and laminated over the mixture 454b and substrate 422 at the junction of cylinders sets 430 and 462. The mixture 454b is used like glue in common lamination process. The printed image over the ITF is faced toward the mixture and is dipped into the mixture 454b. The liquid of the formulation 454b is encapsulated as a thin film in between the two films 422 and 470b capturing the ICM material that are in the imaged area The thickness of the coated layer 454b (layer 220 in FIGS. 2 & 3) may be in the range of 1 to 5 microns.

Other values below 1 micron or above 5 microns may be used depending on the printing application. For example in case of flexo or gravure printing the thickness of coated layer 454b may be in the range of few hundreds of microns. The thickness may be controlled by the speed of substrate 422, the set up of the two sets of cylinders 430 and 462 and the temperature of the formulation.

Some physical properties of layer 220 (FIGS. 2 & 3), 454b-e (FIG. 4a), such as but not limited to face structure; thickness; surface tension; ink repellent/acceptance; scratches resistance; peel strength; etc may be controlled by the properties of the imaged ITF sheet 470b-e.

During the 3^{rd} stage ‘c’, after the lamination, the wet laminated sandwich comprises of the ITF 470c, the dipped image, the mixture 454c and the substrate film 422 is pulled toward the curing station.

In case of using UV curing, the formulation layer 454d may undergo crosslinking/polymerization by free radical mechanism. The curing process generates the solid layer 454e. This mechanism may suffer from well know problem of oxygen inhibition. Due to this phenomenon the free radicals are captured by the oxygen that is in the air and affect the curing process. To over come this problem high energy of UV source is needed. The present invention overcomes this obstacle by using the ITF as a oxygen protectingfilm. The ITF 470d may isolate the formulation 454d from the atmospheric oxygen and therefore less UV energy may be needed.

The sandwich film may undergo UV radiation by the UV source 480. The UV radiation may cure the formulation 454d into a solid layer 454e as well as adhere it to substrate 422. In addition the cured formulation captured the ICM that was imaged over the ITF. ITF 470d may be transparent to UV radiation and having release property in respect to the cured layer 454e. The wavelength of the UV source and the type of illumination, such as flashes or continuously, may be selected upon the characteristic of the mixture 454d. The location of the UV source 480, above or below substrate 422, may depend on different process parameters such as but not limited to the transparency feature of substrate 422. In other embodiments the UV source 480 may be on both sides of substrate 422. After curing, the final film is moved towards the last stage, the cutting stage ‘e’.

The ICM that is used by some embodiments that use upper UV system may be transparent or partial transparent to UV radiation. For example, low optical density black toner, diluted yellow toner or none colored ICM.

The cutting station may have an optical system 484 that scans the backside of the transparent ITF 470e searching for cutting marks. Then the optical system 484 may instruct the cutting system 485 to cut the cured sandwich comprising the substrate 422, the cured formulation 454e & and the imaged ITF 470e in the right location and size and delivers an imaged printing plate 487. The cutting system may cut the sandwich in both axis.

FIG. 4b illustrates another exemplary embodiment of a PPM 400b, which is a PPM without imaging system and having a sheet ITF handling mechanism. PPM 400b differs from PPM 400a in the location of the cutting system 485 and the curing station 480. The optical system 484 and the cutting system 485 have been moved toward the lamination stage, in front of the curing stage. The operation of the optical system with the cutting system may be designed in a way that the cutting is done in a certain location before and after the wetted sandwich. The cutting may be done over a clean substrate 422k, leaving clean substrate margins in both ends of the wetted sandwich. Therefore, the cutting does not affect the wetted sandwich.

After cutting the wetted sandwich is transferred over conveyor 446 to the UV curing station 480 that has been disclosed above. After curing the printing plates 487 are ready to be mounted over a printing machine.

FIG. 4c illustrates another exemplary embodiment 400c of a PPM. PPM 400c doesn't have imaging system and having a sheet ITF handling mechanism. PPM 400c differs from PPM 400a & 400b in the location of the curing station 480. The curing station 480 is located above cylinder 430 near the lamination stage. The curing is done by using UV source 480. UV source 480 radiates the wetted sandwich over the lamination cylinder 430. The location of the curing station improves the accuracy of the process since the curing and fixing of the three part of the sandwich into solid printing plate is done close to the lamination point. The optical system 484 and the cutting system 485 are mounted after the couple of drive rollers 442 & 444. After cutting the printing plates 487 are ready to be mounted over a printing machine.

In exemplary embodiments 400a-c, a registration system, which may be part of cylinder 462, may drive the ITF, printed with ICM 470 in registration together with the substrate 422. This registration system may incorporate a punch system that perforates in a registered way the sandwich comprising the ITF printed with ICM 470, the formulation and the substrate 422. This mechanism may assure the registration and the drive under registered conditions of the imaged ITF 470 and the substrate 422.

FIG. 5a illustrates an exemplary PPM 500a. PPM 500a is an exemplary stand alone PPM having an imaging system as well as a web ITF handling mechanism. The exemplary PPM 500a is using a laser electro photographic printer engine as the engine of the imaging system for printing the image using ICM over continues film of ITF 562. Other embodiments may use other printing engines, such as but not limited to inkjet. Exemplary ICM that may be used by the printing engine is depending on the ITF and the type of the printing engine. Some examples of ITF are described above.

PPM 500a may use a common electro photographic laser printer engine. The principle of operation of such an engine is common knowledge and an example engine is disclosed U.S. Pat. No. 3,867,571, the content of which is incorporated herein by reference. The exemplary printing engine in FIG. 5a comprises a electro photographic drum 510, which rotates clockwise via a cleaning station 520 that cleans the remains from electro-photographic drum 510. The cleaning station 520 is followed by recharge station that is depicted by corona device 532. Then the surface of the drum is exposed by a scanning laser beam 542, along an axis ‘x’ which is parallel to the axis of drum 510. The scanning is done by an optical mechanism 540 according to the image. The laser beam exposes an electrostatic image over the surface of the drum 510.

The electrostatic image over the drum continues through a developing station 550, which contains appropriate ICM (electrostatic toner). The ICM are pulled toward the electrostatic exposed areas over the drum. Then the developed drum passes via a transfer station, depicted by coronal 534 and the junction with the web of ITF 562. At this station the ITF 562 is in contact with the drum 510. At the junction, the ITF receives an electronic discharge from corona 534 and induces transfer of the developed image to the ITF. Then the remains of the ICM continue to the cleaning station 520 and a new cycle starts.

ITF 562 is supplied from a supply reel 560, passes around guide rollers 570 and through lamination rollers 462 and 430. After the transfer station and before the lamination rollers the imaged ITF passes a fusing station 580. The fusing station fixes the image over the ITF. The fusing may be done in a level that is sufficient to hold the image through the lamination as well as allowing the imaged ICM to be transferred into the formulation after the curing and releasing of the ITF. Controlling of the fusion may be achieved by controlling the temperature and/or the duration of the fusing. Other embodiments may use other means for fusing, such as but not limited to drying, UV radiation etc.

The continuous imaged ITF 562a replaces the sheet imaged ITF and the sheet feeder mechanism that are used in the previous examples 400a-c. From the fusing stage to the end of the process the operation of exemplary device 500a can be understood from the description of the operation of device 400b.

FIG. 5b illustrates an exemplary PPM 500b. PPM 500b is an exemplary stand alone PPM having an imaging system as well as a web ITF handling mechanism. PPM 500b differs from PPM 500a in the imaging engine as well as in the lamination section. In the imaging engine one of guide rollers 570 is replaced by cylinder 462a. Cylinder 462a is used also as one of the cylinders, 462a & 430, in the ironing lamination process. The fusion station 580 is located above cylinder 462a. The lamination section is different from the device 500a in the location of the curing station 480, which is above cylinder 430. The operation of device 500b can be understood from the description of devices 500a and 400c.

In other embodiments of device 500b, (not shown in the drawings) the curing system 480 may be located over cylinder 444a. In this embodiment, the curing is done via the substrate 480. Other embodiments may have two curing systems, on both cylinders 430 and 444a. In those embodiments the substrate is transparent to UV radiation.

Cylinder set 444a and 440 may incorporate a punch system (not shown in the drawings) that punches the cured sandwich at a proper location providing registered imaged printing plates ready to be mount over a printing machine.

Other exemplary embodiments of the present invention may use coating by wet lamination instead of coating by ironing lamination. In those embodiments, the formulation of the layer is applied over the substrate by using common methods such as but not limited to silkscreen, wire-wound rod, offset coating, anilox roller, gravure etc. Then the imaged ITF is laminated over the formulation of the layer that is used as glue in common wet lamination. The sandwich is undergoing UV radiation for curing the formulation.

In other exemplary embodiments of the present invention, the PPM may be installed as part of a printing machine. In some embodiments a buffer may be needed as an interface between the PPM and the printing machine.

In other embodiments, in which the PPM is part of a printing machine, cylinder 430 may replace a plate cylinder of the printing machine.

Other embodiments may use a sheet substrate instead of web substrate

The formulation is kept in different compartments 450a-c. Each component may be in a different compartment and each compartment may have one or more than one component. Furthermore, each cartridge may contain a complete formulation that fit certain printing conditions. In a way that the plurality of cartridges may cover a plurality of printing applications.

In some embodiments at least one cartridge may have a stirring/agitation mechanism. One compartment may contain additional formulation skeleton for further dilution, when applicable. The formulation may be mixed on demand by the coating machine. The concept of multi-compartment cartridge has many advantages, such as:

i. Variable mixture ratios control (S/W & H/W)

ii. Disposable

iii. Comprises built in compounds homogenization device

iv. Long shelf life of none blended ingredients.

v. Designed to be transported for any vehicle such as airplane.

vi. Adapting the formulation to the printing application.

Other exemplary embodiments may use a thermal system that controls the temperature of the lamination process. The thermal system may be incorporated with cylinders 430, 432a and in the formulation system 450a-c or 452.

Other exemplary embodiments may use sheet ITF. The sheet ITF may have capsules of formulation that may be attached along upper margin of the substrate sheet. Then, during lamination process the capsule break off supplying the required mixture. The size of the capsule and the quantity of the formulation mixture may fit the size of the substrate sheet. In other exemplary embodiment the capsules of formulation may reside on the substrate.

In other embodiments the substrate may be pre-coated with a formulation, which is solid at room temperature. In this case the lamination process may be performed at relative elevated temperature where the solid formulation may melt before applying the ITF.

Overall, this invention will improve the sensitivity of the printing member to the laser radiation. The present invention reduces the cost of a printing plate. Furthermore the present invention discloses a method and an apparatus for delivering printing plate on demand and improves the inventory management and the flexibility of a printing house. The on demand process may be adapted to fit printing properties and improve the quality of the end product. Thus, this invention will be useful for the printing industry.

In the description and claims of the present application, each of the verbs, “comprise” “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1-21. (canceled)

22. A method for fabricating an imaged lithographic printing member on demand, the method comprising:
transferring an image onto a lithographic printing member during fabrication of the lithographic printing member by transferring an imaging-carrying material from an imaged image-transfer film into a fluid formulation, the fluid formulation captured in between a substrate of the lithographic printing member and the imaged image-transfer film and curing the fluid formulation to form a solid imaging layer comprising a mirror image of said image.

23. The method of claim 22, wherein the curing comprises curing with UV radiation.

24. The method of claim 22, wherein the curing comprises curing with thermal radiation.

25. The method of claim 22, wherein the curing comprises solidification by cooling.

26. The method of claim 22, wherein transferring said image comprises laminating the imaged image-transfer film with the substrate such that the fluid formulation captured in between and the imaging-carrying material is dipped into the fluid formulation using a wet lamination process.

27. The method of claim 22, wherein transferring said image comprises laminating the imaged image-transfer film with the substrate-such that the fluid formulation is captured in between and the imaging-carrying material is dipped into the fluid formulation using an ironing lamination process.

28. The method of claim 22, wherein transferring said image comprises laminating the imaged image-transfer film with the substrate such that the fluid formulation is captured in between and the imaging-carrying material is dipped into the fluid formulation using a hot lamination process.

29. The method of claim 22, wherein the imaging-carrying material is a toner.

30. The method of claim 22 further comprising:
releasing the image-transfer film from said imaging layer to expose on a surface of said imaging layer the mirror image of said image, wherein areas of said surface comprising said mirror image of said image and the remaining area of said surface have different affinities for ink and/or ink-repellent fluid.

31. A method of fabricating an imaged lithographic printing member, the method comprising:
imaging a selected image onto an image-transfer film by applying an imaging-carrying material on selected areas of said image-transfer film; applying a fluid formulation onto a substrate and/or the imaged image-transfer film;
laminating the imaged image-transfer film with the substrate such that the fluid formulation is captured in between and the imaging-carrying material is dipped into the fluid formulation; and
curing the fluid formulation to form a solid imaging layer, said solid imaging layer comprising said imaging-carrying material such that a surface of said imaging layer comprises a mirror image of said selected image.

32. The method of claim 31 further comprising:
releasing the image-transfer film from said imaging layer such that said mirror image of said selected image is exposed.

33. The method of claim 31, wherein the mirror image of said selected image and the remaining area of said surface have different affinities for ink and/or ink-repellent fluid.

34. The method of claim 31, wherein the curing comprises curing with UV radiation.

35. The method of claim 31, wherein the curing comprises radiating UV energy onto the image-transfer film.

36. The method of claim 31, wherein the curing comprises radiating UV energy onto the substrate.

37. The method of claim 31, wherein the image-transfer film is used as a protective film and is released prior to printing.

38. The method of claim 31, wherein the imaging comprises printing said selected image onto the image transfer film using a laser printer.

39. An imaged lithographic printing member comprising:
a solid substrate; and
an imaging layer over the substrate, wherein an imaged area of a surface of said imaging layer comprises a mirror image of a selected image,
said imaged lithographic printing member is produced by:
imaging the selected image onto an image-transfer film by applying an image-carrying material onto said image-transfer film;
applying a fluid formulation onto said substrate and/or the imaged image-transfer film;
laminating the imaged image-transfer film with the substrate such that the fluid formulation is captured in between and the imaging-carrying material is dipped into the fluid formulation; and
curing the fluid layer to form said imaging layer such that the imaged areas comprise the mirror image of the selected image.

40. The imaged lithographic printing member of claim 39, wherein the imaged area and a non-imaged area of said surface have different affinities for ink and/or ink-repellent fluid.

41. The imaged lithographic printing member of claim 40, wherein the imaged area is oleophilic and the non-imaged area is oleophobic.

42. The imaged lithographic printing member of claim 40, wherein the imaged area is oleophilic and hydrophobic and the non-imaged area is hydrophilic.

43. The imaged lithographic printing member of claim 39, wherein the substrate is transparent to ultraviolet radiation.

44. The imaged lithographic printing member of claim 39, wherein the image-transfer film is transparent to ultraviolet radiation.

45. The imaged lithographic printing member of claim 40, wherein the imaging-carrying material is an electro photography toner.

46. An on-demand plate-making apparatus comprising:
a substrate handling unit to hold and conduct a substrate,
a lamination handling unit to hold and conduct an imaged image-transfer
film having an imaging-carrying material thereon; and
an applicator to apply a fluid formulation onto the substrate and/or the imaged image-transfer film,
wherein during the lamination of the imaged image-transfer film with the substrate the fluid formulation is captured in between the imaged image-transfer film and the substrate and the imaging-carrying material is dipped into the fluid formulation.

47. The apparatus of claim 46 further comprising:
a curing unit to cure the fluid formulation to form a solid imaging layer.

48. The apparatus of claim 46 further comprising:
a printing engine to place an imaging-carrying material onto a non-imaged image-transfer film.

49. The apparatus of claim 46, wherein the apparatus is installed in a printing machine.

50. The apparatus of claim 46 further comprising:
a formulation mixing unit to prepare the fluid formulation.
